(19) United States
(12) Patent Application Publication
(10) Pub. No.: US 2005/0223121 A1
(43) Pub. Date: Oct. 6, 2005

(54) Pin-sharing system

(76) Inventor: Chung-hung Tsai, Chu-Pei City (TW)

Correspondence Address: HOFFMAN WARNICK & D'ALESSANDRO, LLC, 75 STATE STREET, 14TH FL, ALBANY, NY, 12207, US

(21) Appl. No.: 11/096,456

(22) Filed: Apr. 1, 2005

(30) Foreign Application Priority Data
Apr. 2, 2004 (TW) 093109315

(51) Int. Cl. G06F 13/14

(52) U.S. Cl. 710/2

(57) ABSTRACT

The invention relates to a pin-sharing system which comprises an integrated circuit, a first device, a second device, a memory device, a first set of wiring lines, a second set of wiring lines, and a third set of wiring lines. The integrated circuit comprises a first pin group and a second pin group. The first device comprises a first set of data pins. The second device comprises a set of I/O pins. The memory device comprises a first set of address pins, a second set of address pins, and a set of memory data pins. The first set of wiring lines connects the first set of data pins, the first set of address pins, and the first pin group. The second set of wiring lines connects the set of memory data pins, the set of I/O pins, and the second pin group, wherein the second set of wiring lines comprises a buffer connected between the set of I/O data/address pins and the second pin group, and the buffer temporarily stores a set of address signals, sending the set of address signals to the second device upon receiving an address-latch instruction. The third set of wiring lines connects the second set of address pins, the buffer, and the second pin group.

### BACKGROUND OF THE INVENTION

1. Field of the invention

This present invention relates to a pin-sharing system, wherein the pin-sharing system is capable of simultaneously connecting multiple peripheral devices to an integrated circuit.

2. Description of the prior art

As the technology in semiconductor progresses, the functions of the general integrated circuit becomes more and more complex; some of the integrated circuits can even control multiple devices. However, there is a problem when multiple devices are all connected to the same integrated circuit. Due to various technical issues, the number of external connecting pins within a single IC (integrated circuit) package is limited. Therefore, the pin-sharing system is a popular structure in computers; the pin-sharing system is capable of connecting multiple peripheral devices to an integrated circuit. The integrated circuit controls each of the devices, so it needs wiring lines to connect the pins of the integrated circuit with the pins of the peripheral device. The integrated circuit can transmit signals to the peripheral devices through the pins. The pins of the integrated circuit are shared by the multiple peripheral devices, so it is important to prevent conflicts when the integrated circuit desires to transmit signals to one or more of the peripheral devices.

For example, with the techniques disclosed in U.S. Pat. No. 6,044,412, the pin-sharing system can be applied among peripheral devices like a dynamic memory device (e.g. CD-ROM) and a static memory device (e.g. ROM). However, because the pins of the multiple peripheral devices share the same wiring line, devices with the same shared wiring line cannot simultaneously communicate with the integrated circuit. As a result, the bandwidth efficiency is not high. If devices can be simultaneously controlled by the integrated circuit through sharing the wiring lines or pins, the efficiency of the system will be improved.

### SUMMARY OF THE INVENTION

Accordingly, it's an object of the present invention to provide a pin-sharing system to simultaneously connect the peripheral devices to the integrated circuit.

According to the embodiment, the pin-sharing system comprises an integrated circuit, a first device, a second device, a memory device, a first set of wiring lines, a second set of wiring lines, and a third set of wiring lines. The integrated circuit comprises a first pin group and a second pin group. The first device comprises a first set of data pins. The second device comprises a set of I/O pins, which include data and address pin. The memory device comprises a first set of address pins, a second set of address pins, and a set of memory data pins. The first set of wiring lines connects the first set of data pins and the first set of address pins to the first pin group. The second set of wiring lines connects the set of memory data pins and the set of I/O pins to the second pin group, wherein the second set of wiring lines comprises a buffer connected between the set of I/O pins and the second pin group; the buffer temporarily stores a set of address signals for later sending the set of address signals to the second device upon receiving an address-latch instruction. The third set of wiring lines connects the second set of address pins of the memory device, the set of I/O pins and the buffer of the second set of wiring lines to the second pin group of the integrated circuit.

The pin-sharing system can allow the integrated circuit to simultaneously control several peripheral devices, and it also allows the pins of the integrated circuit to be shared by the peripheral devices, so as to improve the operating efficiency of the peripheral devices and to reduce the number of pins needed in the IC package.

### BRIEF DESCRIPTION OF THE APPENDED DRAWINGS

FIG. 1 is a schematic diagram of the first embodiment of the pin-sharing system of the present invention.

FIG. 2 is a schematic diagram of the integrated circuit in the pin-sharing system.

FIG. 3 is a schematic diagram of the second embodiment of the pin-sharing system of the present invention.

FIG. 4 is a schematic diagram of the third embodiment of the pin-sharing system of the present invention.

### DETAILED DESCRIPTION OF THE INVENTION

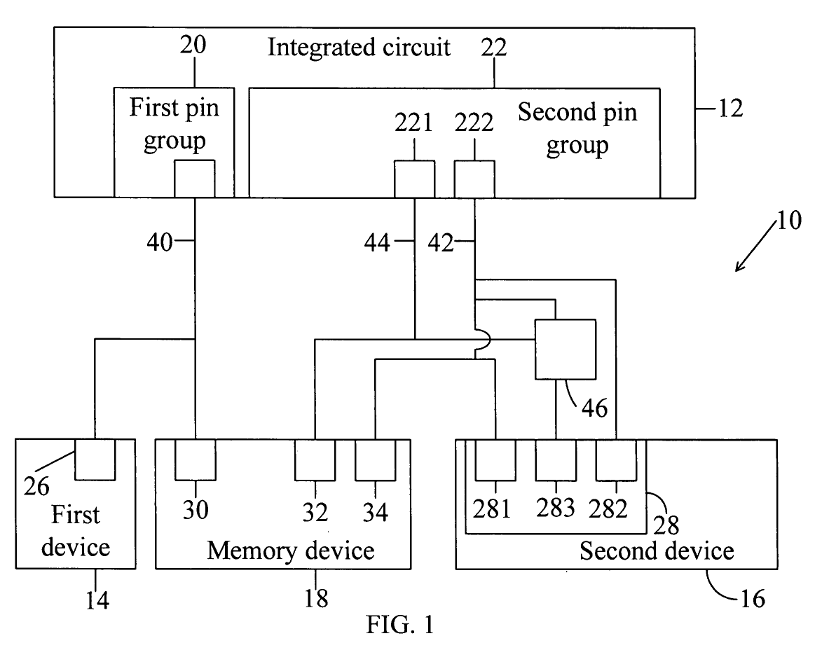

Referring to FIG. 1, FIG. 1 is the schematic diagram of the first embodiment of the pin-sharing system 10. The pin-sharing system 10 comprises an integrated circuit 12, a first device 14, a second device 16, and a memory device 18. The integrated circuit 12 comprises a first pin group 20 and a second pin group 22. The first device 14 comprises a first set of data pins 26, and the second device 16 comprises a set of I/O pins 28. The memory device 18 comprises a first set of address pins 30, a second set of address pins 32, and a set of memory data pins 34.

In this embodiment, the pin-sharing system 10 comprises a first set of wiring lines 40, a second set of wiring lines 42, and a third set of wiring lines; they connect the integrated circuit 12, the first device 14, the second device 16, and the memory device 18. The first set of wiring lines 40 connects the first set of data pins 26 and the first set of address pins 30 to the first pin group 20. The set of wiring lines 42 connects the set of memory data pins 34 and the set of I/O pins 28 to the second pin group 22 of the integrated circuit 12. The second set of wiring lines 42 comprises a buffer connected between the set of I/O pins 28 and the second pin group 22, and the buffer temporarily stores a set of address signals for later sending the set of address signals to the second device upon receiving an address-latch instruction, wherein the set of I/O pins 28 comprises a set of data input pins 281 of the second device, a set of data output pins 282 of the second device, and a set of address pins 283 of the second device, wherein the buffer 46 is connected between the set of address pin 283 of the second device and the second pin group 22. The third set of wiring lines 44 connects the second set of address pins 32 and the buffer 46 of the second set of wiring lines 42 to the second pin group 22, wherein the second pin group 22 of the integrated circuit 12 comprises a set of address pins 221 of the integrated circuit and a set of data pins 222 of the integrated circuit, so that the second set of wiring lines 42 can be connected to the set of data pins 222 of the second pin group 22. Furthermore, the third set of wiring lines 44 can be connected to the set of address pins 221 of the second pin group 22.

Table 1 is a wiring line table, which describes the relationship between each set of wiring lines, the first device 14, the second device 16, and the memory device 18:

TABLE 1

| | The first set of | The second set of | The third set of |
|---|---|---|---|
| | wiring lines 40 | wiring lines 42 | wiring lines 44 |
| The first | The set of data | None | None |
| device 14 | pins 26 | | |
| The second | None | The set of I/O pins | None |
| device 16 | | 28 | |
| The memory | The first set of | The set of memory | The second set of |
| device 18 | address pins 30 | data pins 34 | address pins 32 |

Referring to table 1, table 1 shows the connections between the first set of wiring lines 40, the second set of wiring lines 42, the third set of wiring lines 44, the first device 14, the second device 16, and the memory device 18. The first device 14 and the second device 16 are not sharing the same set of wiring lines in this pin-sharing system. The first set of address pins 30 of the memory device 18 and the set of data pins 26 of the first device 14 share the first set of wiring lines 40 to transmit data to the first pin group 20 of the integrated circuit 12. The set of memory data pins 34 of the memory device 18 and the set of I/O pins 28 of the second device 16 shares the second set of wiring lines 42, so as to transmit data to the set of data pins 222 of the integrated circuit of the second pin group 22. The third set of wiring lines connects the second set of address pins 32 of the memory device 18 and the buffer 46 of the second set of wiring lines 42 to the first set of address pins 221 of the second pin group 22. The first device 14 and the memory device 18 share the first pin group of the integrated circuit 12. The second device 16 and the memory device 18 share the set of address pins 221 of the integrated circuit and the set of data pins 222 of the integrated circuit.

Table 2 is the signal table that shows the corresponding signals within the pin-sharing system 10 when different devices are used.

TABLE 2

| | | Using | Using the | |
|---|---|---|---|---|
| | Using the | the first | second | Using the |
| | memory device | device | device | third device |
| The first set of | The first- | The data | None | The data |
| wiring lines | address signal | signal | | signals of |
| 40 | | | | first device |
| The second set | The memory | None | The data | The data or |
| of wiring lines | data signal | | or address | address |
| 42 | | | signal | signals of |
| | | | | second |
| | | | | device |
| The third set | The second | None | The address- | The address- |
| of wiring lines | address signals | | latch | latch |
| 44 | | | instruction | instruction |

Referring to table 2, each column of the table represents the signals transmitted by the three sets of wiring lines when each device is operating. When the memory device 18 is used, the first set of wiring lines 40 is used to transmit the first address signals; the second set of wiring lines 42 is used to transmit the memory data signals, and the third set of wiring lines 44 transmits the second address signals to the memory device 18. When the first device is used, the first set of wiring lines 40 is used to transmit the data signals.

When data is being written into the second device 16, the second set of wiring lines 42 is used to transmit data or address signals to the second device 16 in a time-sharing manner, and the third set of wiring lines 44 is used to transmit Address Latch Enable (ALE) to the buffer 46. At this time, the second set of wiring lines 42 transmits the address signals immediately to the buffer 46 and waits for the address latch order. Then, the third set of wiring lines 44 transmits the address latch enable to the buffer 46, so the buffer can transmit the address data to the second set of data pins 283 of the second device 16. In the second time interval, the second set of wiring lines 42 transmits another set of data signals to the second set of data pins 281 of the second device 16. Because the first device 14 and the second device 16 do not share any wiring lines or pins, the first device and the second device can simultaneously operate in the pin-sharing system 10.

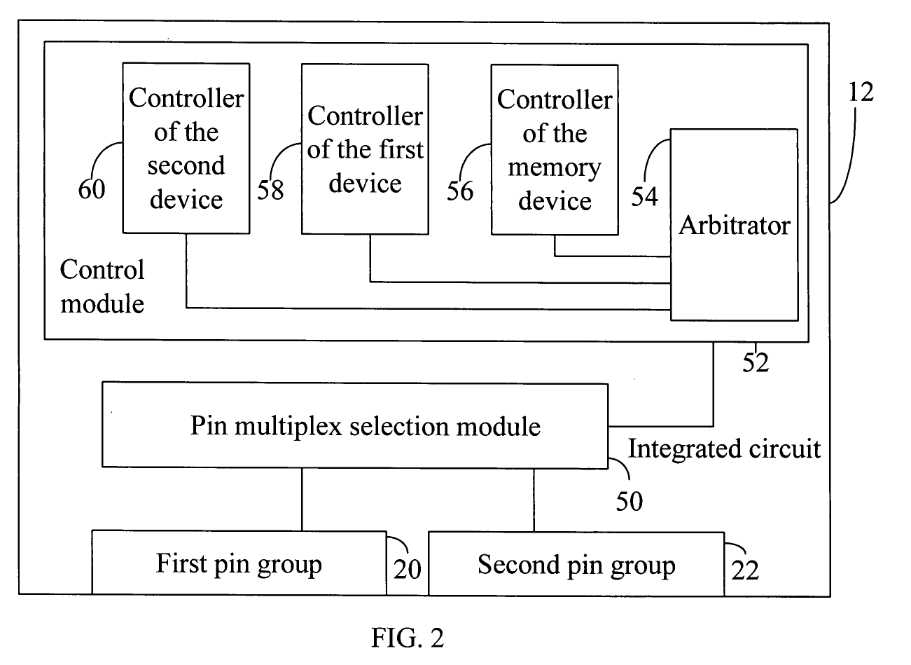

Referring to FIG. 2, FIG. 2 is a diagram of the integrated circuit 12 of FIG. 1. The integrated circuit 12 determines the using order of the memory device, the first device, and the second device. The integrated circuit 12 comprises a pin multiplex selection module 50 and a control module 52. The control module 52 comprises an arbitrator 54, a controller of the memory device 56, a controller of the first device 58, and a controller of the second device 60, for determining this using order of the devices. The arbitrator 54 controls the pin selection module 50 to connect with the first pin group 20 and the second pin group 22, so as to transmit the control signals of the controller of the memory device 56, the controller of the first device 58, and controller of the second device 60 to the first pin group 20 and the second pin group 22; moreover, from the first set of wiring lines, the second set of wiring lines, and the third set of wiring lines, a plurality of signals are communicated with the peripheral devices.

When the memory device is being used, the arbitrator 54 of the control module 52 arbitrates the controller of the memory device 56 to access the pin multiplex selection module 50. Furthermore, the pin multiplex module 50 further assigns the corresponding pins within the first set of wiring lines 40, the second set of wiring lines 42, and the third set of wiring lines 44 to the controller of the memory 56, so as to transmit the signals and control the memory device 18.

When the memory device 18 is not being used, the arbitrator 54 of the control module 52 arbitrates the controller of the first device 58 and the controller of the second device 60 to determine whether the devices are usable. At this time, the controller of the first device 58 can access the first device 14. Simultaneously, the controller of the second device 60 can access the second device 16. The pin multiplex selection module 50 further assigns the third set of wiring lines 44 and the second set of wiring lines 42 to the controller of the second device 60 and the second device 16, and the first set of wiring lines 40 is assigned to the controller of the first device 58 and the first device 14, thereby the integrated circuit 12 simultaneously transmits signals to the first device 14 and the second device 16.

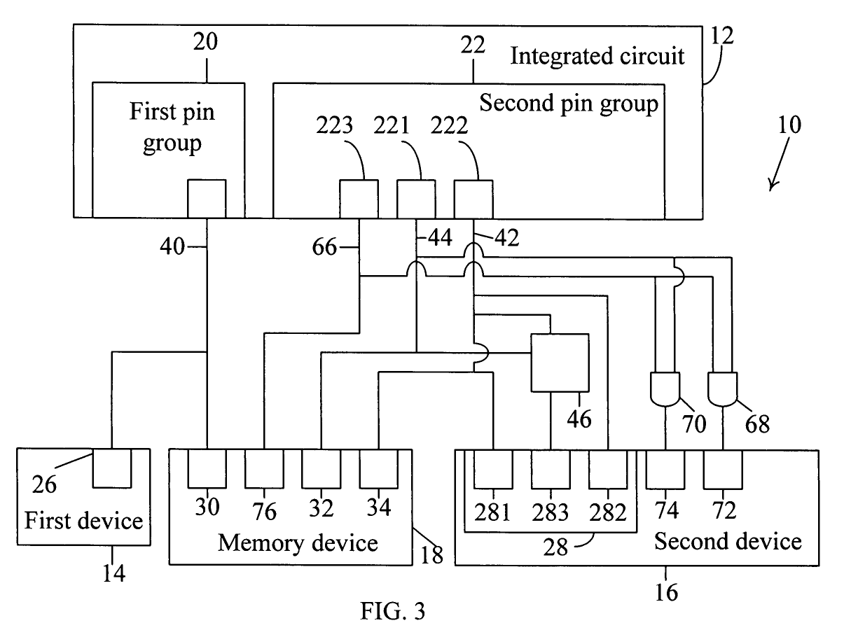

Referring to FIG. 3, FIG. 3 is a schematic diagram of the second embodiment of the, pin-sharing system 10. Comparing with the previous embodiment, the current embodiment further adds a fourth set of wiring lines 66, a first logic gate 68, and a second logic gate 70. The fourth set of wiring lines 66 is coupling to the set of read pins 72 and the set of write pins 74 of the second device 16 by the above-mentioned logic gates and connecting to the set of memory control pins 76 of the memory device 18 and the set of control pins 223. The first logic gate 68 is connected with the third set of wiring lines 44, the fourth set of wiring lines 66 and the set of read pins 72. The second logic gate 70 is connected with the third set of wiring lines 44, the fourth set of wiring lines 66 and the set of write pins 74 Moreover, the third set of wiring lines 44 is connected with the second pin group 22, the first logic gate 68 and the second logic gate 70, so as to control the transmission of the set of read pins 72 and write pins 74 to the second device 16.

Referring to table 3, Table 3 is the pin-sharing table of each set of pins respectively shared by the different sets of wiring lines connected to the first device 14, the second device 16, and the memory device 18 in the second embodiment:

TABLE 3

| | The first set of | The second set of | The third set of | The fourth set of |
|---|---|---|---|---|
| | wiring lines 40 | wiring lines 42 | wiring lines 44 | wiring lines 66 |
| The first | The set of data | None | None | None |
| device 14 | pins 26 | | | |
| The second | None | The set of I/O 28 | The set of read | The set of read |
| device 16 | | | pins 72 and the | pins 72 and the set |
| | | | set of write pins | of write pins 74 |
| | | | 74 are | are connected |
| | | | connected | through the first |
| | | | through the first | and the second |
| | | | and the second | logic gate |
| | | | logic gate | respectively |
| | | | respectively | |
| The memory | The first set of | The set of | The second set | The set of memory |
| device 18 | address pins 30 | memory data pins | of address pins | control pins 76 |
| | | 34 | 32 | |

Compared to the first embodiment, the second embodiment further comprises the fourth set of wiring lines 66 communicating among the set of read pins 72, the set of write pins 74, the set of memory control pins 76, thereby the set of control pins 223 of the second pin group 22 can be shared by the second device 16 and the memory device 18, and the fourth set of wiring lines is not connected to the first device 14. The first device 14 and the memory device 18 share the first pin group 40. The second device 16 and the memory device 18 share the set of address pins 221, the set of data pins 222, and the set of control pins 223.

Referring to table 4, Table 4 is the signal table that shows the corresponding signals of the second embodiment when different devices are used.

TABLE 4

| | Using the | | | Using the first and |
|---|---|---|---|---|
| | memory | Using the first | Using the | second device |
| | device | device | second device | simultaneously |
| The first set of | The first | The data | None | The data signal |
| wiring lines | address signal | signal | | |
| 40 | | | | |
| The second set | The memory | None | The data or | The data or address |
| of wiring lines | data signal | | address signal | signal |
| 42 | | | | |
| The third set | The second | None | The address- | The address-latch |
| of wiring lines | address signal | | latch | instruction and I/O |
| 44 | | | instruction and | read/write signal |
| | | | I/O read/write | |
| | | | signal | |
| The fourth set | The memory | None | The memory | The memory control |
| of wiring lines | control signal | | control signal | signal |
| 66 | | | | |

Each column of the table represents the signals transmitted by the three sets of wiring lines when each device is operating. When the memory device is being used, the first set of wiring lines 40, the second set of wiring lines 42, and the third set of wiring lines 44 are used by the memory device 18. The fourth set of wiring lines 66 is used to transmit the memory control signals to the set of memory control pins 76 under this condition. When the first device 14 is being used, the set of wiring lines 40 is used to transmit data signals to the first device 14. When the second device 16 is used, beside the signal transmission system of the first embodiment, the third set of wiring lines 44 further transmits I/O signals including read or write signals to the first logic gate 68 and the second logic gate 70. The fourth set of wiring lines 66 transmits the memory idle signal to the first logic gate 68 and the second logic gate 70. The two sets of logic gates determine the value of I/O signal and the memory control signal, and the result of the logic operation is transmitted to the set of read pins 72 and the set of write pins 74 respectively. The integrated circuit 12 still simultaneously transmits signals to the first device 14 and the second device 16.

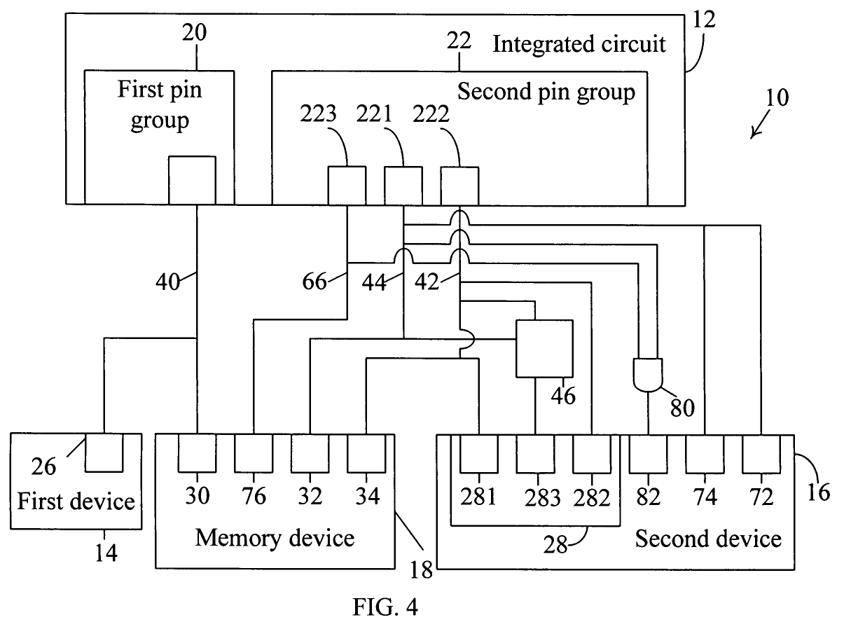

Referring to FIG. 4, FIG. 4 is a schematic diagram of the third embodiment. Compared to the first embodiment, the third embodiment further adds the fourth set of wiring lines 66 and the third logic gate 80. The fourth set of wiring lines 66 communicates the set of device control pins 82 of the second device 16 through the third logic gate 80 and the set of memory control pins 76 of the memory device 18 to the set of control pins 223 of the second pin group 22. The third set of wiring lines 44 is connected with the third logic gate 80. The third logic gate 80 is connected with the set of device control pins 82 of the second device 16. The third set of wiring lines 44 is connected with the set of read pins 72 and the set of write pins 74 of the second device 16.

According to the first device of the pin-sharing system of the present invention, it can be an integrated device electronic device of the integrated electronic interface. The second device can be one that comprises a micro controller device of a controller; the memory device can be a flash memory.

Compare the embodiments of the present invention to the traditional pin-sharing system. In the embodiments of the present invention, the multiple peripheral devices share the pins of the integrated circuit and use the time multiplexing technique more compactly than the traditional one, so as to improve the operating efficiency of the peripheral devices and to reduce the number of pins needed in the integrated circuit package.

With the example and explanations above, the features and spirits of the embodiment will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A pin-sharing system, the pin-sharing system comprising:
an integrated circuit, the integrated circuit comprising a first pin group and a second pin group;
a first device, the first device comprising a first set of data pins;
a second device, the second device comprising a set of I/O pins;
a memory device, the memory device comprising a first set of address pins, a second set of address pins, and a set of memory data pins;
a first set of wiring lines, the first set of wiring lines connecting the first set of data pins and the first set of address pins to the first pin group;
a second set of wiring lines connecting the set of memory data pins and the set of I/O pins to the second pin group, wherein the second set of wiring lines comprises a buffer connected between the set of I/O pins and the second pin group, and the buffer temporarily stores a set of address signals, sending the set of address signals to the second device upon receiving an address-latch instruction; and
a third set of wiring lines, the third set of wiring lines connecting the second set of address pins of the memory device and the buffer of the second set of wiring lines to the second pin group of the integrated circuit.

2. The pin-sharing system of claim 1, wherein the integrated circuit controls a plurality of signals transmitted through the first set, the second set, and the third set of wiring lines to the memory device, the first device, and the second device, whereby the integrated circuit simultaneously communicates with the first device and the second device.

3. The pin-sharing system of claim 2, wherein the integrated circuit further comprising:
a control module, comprising a controller of the memory device, a controller of the first device, and a controller of the second device, for determining a connecting sequence of the memory device, the first device, and the second device;
a pin multiplex selection module, for selectively sending the plurality of signals through the first set of wiring lines, the second set of wiring lines, or the third set of wiring lines.

4. The pin-sharing system of claim 1, wherein the second pin group comprises an address pin coupling to the third set of wiring lines and a data pin coupling to the second set of wiring lines.

5. The pin-sharing system of claim 1, wherein the set of I/O pins of the second device comprises an input data pin of the second device, an output data pin of the second device, and an address pin of the second device coupling to the buffer connected with the second pin group.

6. The pin-sharing system of claim 1, the pin-sharing system further comprising:
a fourth set of wiring lines coupling a first logic gate coupling to a read pin of the second device, a second logic gate coupling to a write pin of the second device, a control pin of the memory device, and a control pin of the second pin group, wherein the first and second logic gates further coupling to the third set of wiring lines.

7. The pin-sharing system of claim 1, the pin-sharing system further comprising:
a fourth set of wiring lines coupling a third logic gate coupling to a control pin of the second device, a control pin of the memory device, and a control pin of the second pin group, wherein the third logic gate coupling a read pin of the second device, a write pin of the second device, and the third set of wiring lines.

8. The pin-sharing system of claim 6 or claim 7, wherein the integrated circuit controls a plurality of signals transmitted through the first set, the second set, the third set, and the fourth set of wiring lines to the memory device, the first device, and the second device, whereby the integrated circuit simultaneously communicates with the first device and the second device.

9. The pin-sharing system of claim 8, the integrated circuit comprising:
a control module, comprising a controller of the memory device, a controller of the first device, and a controller of the second device, for determining a connecting sequence of the memory device, the first device, and the second device;
a pin multiplex selection module, for selectively sending the plurality of signals through the first set of wiring lines, the second set of wiring lines, the third set of wiring lines, or the fourth set of wiring lines.

10. The pin-sharing system of claim 1, wherein the first device comprises an integrated device electronic device.

11. The pin-sharing system of claim 1, wherein the second device comprises a micro controller device.

12. The pin-sharing system of claim 1, wherein the memory device comprises a flash memory.

13. The pin-sharing system of claim 7, wherein the integrated circuit controls a plurality of signals transmitted through the first set, the second set, the third set, and the fourth set of wiring lines to the memory device, the first device, and the second device, whereby the integrated circuit simultaneously communicates with the first device and the second device.
